(19) United States
(12) Patent Application Publication
(10) Pub. No.: US 2025/0209319 A1
(43) Pub. Date: Jun. 26, 2025

(54) DEEP LEARNING COMPILING METHOD FOR NEURAL NETWORK MODEL AND A NON-TRANSITORY COMPUTER READABLE MEDIA FOR STORING CORRESPONDING PROGRAM

(71) Applicant: INDUSTRIAL TECHNOLOGY RESEARCH INSTITUTE, Hsinchu (TW)

(72) Inventors: Kuen-Wey Lin, Zhudong Township (TW); Shun-Ho Lee, Tainan City (TW); Yan-Ying Li, Taipei City (TW); Ming-Chih Tung, Taoyuan City (TW)

(73) Assignee: INDUSTRIAL TECHNOLOGY RESEARCH INSTITUTE, Hsinchu (TW)

(21) Appl. No.: 18/776,992

(22) Filed: Jul. 18, 2024

(30) Foreign Application Priority Data
Dec. 25, 2023 (TW) 112150627

(51) Int. Cl. G06N 3/08

(52) U.S. Cl. CPC G06N 3/08

(57) ABSTRACT

A deep learning compiling method for neural network model is provided. A number of predetermined execution time values required to execute a number of predetermined schedules for each operation of a neural network model in a number of different hardware backends are estimated. Based on the predetermined execution time values, one of the predetermined schedules corresponding to each operation of the hardware backends is selected as a candidate schedule corresponding to each operation of the hardware backends. The candidate schedule corresponding to each operation of the hardware backends and the corresponding candidate execution time value are recorded in a table. An intermediate representation of the neural network model is split according to the table. According to the split intermediate representations and the table, a deep learning compiling process is executed to perform the operations on at least two different hardware backends.

This application claims the benefit of Taiwan application Serial No. 112150627, filed Dec. 25, 2023, the disclosure of which is incorporated by reference herein in its entirety.

### TECHNICAL FIELD

The disclosure relates in general to a deep learning compiling method for neural network model and a non-transitory computer readable media for storing corresponding program.

### BACKGROUND

Along with the advance in technology, the application of artificial intelligence (AI) is becoming increasingly diversified. Various accelerator platforms for AI operations are provided one after another, and there are many neural network models capable of achieving desired tasks. In general, a neural network model can be compiled using a deep learning compiler, thereby enabling it to perform inference tasks.

Due to the advance in AI technology, people's requirements of the processing speed of a neural network model are also getting higher and higher. Therefore, it has become a prominent task for the industries to increase the processing speed of neural network model.

### SUMMARY

According to one embodiment, a deep learning compiling method for neural network model is provided. The method includes following steps. A neural network model is provided, wherein the neural network model has a number of operations, and each operation corresponds to a number of predetermined schedules. A number of predetermined execution time values required to execute the predetermined schedules for each operation in a number of different hardware backends are estimated. Based on the predetermined execution time values, one of the predetermined schedules corresponding to each operation of the hardware backends is selected as a candidate schedule corresponding to each operation of the hardware backends. The predetermined execution time value corresponding to the candidate schedule corresponding to each operation of the hardware backends is used as a candidate execution time value, and the candidate schedule corresponding to each operation of the hardware backends and the corresponding candidate execution time value are recorded in a table. An intermediate representation of the neural network model is split according to the table. According to the split intermediate representations and the table, a deep learning compiling process is executed to perform the operations of the neural network model on at least two different hardware backends among the hardware backends to execute an inference task.

According to another embodiment, a non-transitory computer readable media used to store a programming code for executing the method mentioned above.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a method for guiding a deep learning compiler to deploy a neural network model in a heterogeneous accelerator platform according to a deployment table;

FIG. 2 is another schematic diagram of a method for guiding a deep learning compiler to deploy a neural network model in a heterogeneous accelerator platform according to a deployment table;

FIG. 3 is a flowchart of a deep learning compiling method for neural network model according to an embodiment of the present disclosure;

FIG. 4 is a schematic diagram of identifying a preferred schedule for a number of operations of a neural network model;

FIG. 5 is an example of a table recording a number of candidate schedules and candidate execution time values according to an embodiment of the present disclosure;

FIG. 6 is a schematic diagram of transferring operation data between different hardware backends;

FIG. 7 is another schematic diagram of transferring operation data between different hardware backends;

FIG. 8 is another example of table corresponding to FIG. 7;

FIG. 9 is a schematic diagram of an intermediate representation for splitting a neural network model;

FIGS. 10A and 10B are an example of a table recording the candidate schedules and candidate execution time values corresponding to at least one parameter corresponding to each operation;

FIG. 11A is a flowchart of an example of complete action of a compiler using a deep learning compiling method for neural network model according to the present disclosure;

FIG. 11B is a flowchart of detailed steps of step 1106 of FIG. 11A; and

FIG. 12A to FIG. 12F are an example of executing a deep learning compiling method for neural network model according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Generally speaking, when designing a neural network model, the major concern is usually placed on its application (such as classification, object recognition, and natural language processing). However, the deployment of a neural network model in a heterogeneous accelerator platform is seldom taken in consideration in the design of a neural network model.

In the design of a deep learning compiler, the major concern is often placed on the optimization of operation process or operator in the model. Nonetheless, how to use a new heterogeneous accelerator platform is less taken into consideration.

In the design of a heterogeneous accelerator platform nowadays, the major concern is how to maximize computational performance under physical conditions. However, how to use heterogeneous accelerator platform for the distribution of a neural network model is less mentioned in the design of a current heterogeneous accelerator platform.

Current deep learning compiler is directed to supporting different neural network models and accelerators. Since there are various combinations of accelerators that can be utilized to form a platform, current deep learning compiler is unable to deploy a neural network model in a heterogeneous accelerator platform. In other words, the existing deep learning compiler lacks the capability to compile a neural network model for a heterogeneous accelerator platform, which can be one of numerous combinations of accelerator.

Therefore, the present disclosure provides a method for guiding a deep learning compiler to deploy a neural network model in a heterogeneous accelerator platform through the use of a deployment table. For the heterogeneous accelerator platform, a deployment table is generated through efficiency analysis and adjustment of operator; then based on the table, the deep learning compiler is guided to split the neural network model and deploy the split neural network models in the heterogeneous accelerator platform to accelerate the inference speed of the neural network model. Details are disclosed below.

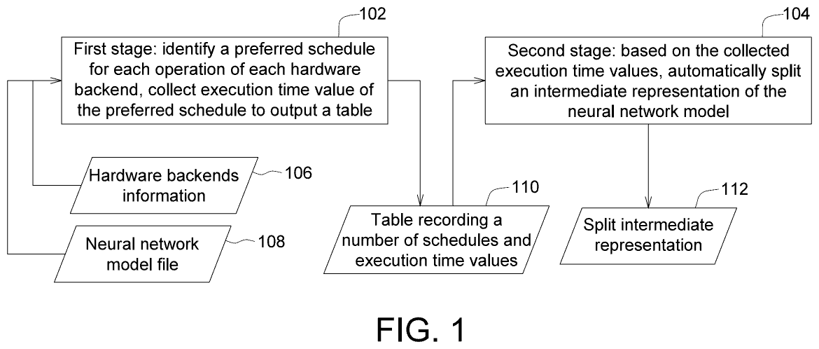

Referring to FIG. 1, a schematic diagram of a method for guiding a deep learning compiler to deploy a neural network model in a heterogeneous accelerator platform according to a deployment table is shown. The method includes a first stage 102 and a second stage 104. In the first stage 102, hardware backends information 106 and neural network model file 108 are received, a preferred schedule for each operation of each hardware backend is identified and execution time value of the preferred schedule is collected to output a table 110. The table 110 records a number of schedules and execution time values. Then, the method proceeds to the second stage 104, and based on the collected execution time values, an intermediate representation of the neural network model is automatically split and the split intermediate representation 112 is outputted.

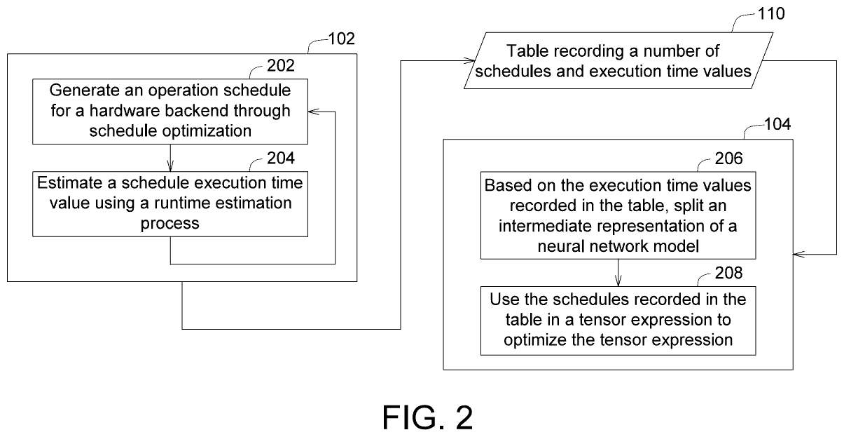

Referring to FIG. 2, another schematic diagram of a method for guiding a deep learning compiler to deploy a neural network model in a heterogeneous accelerator platform according to a deployment table is shown. Furthermore, the first stage 102 may include steps 202 and 204, for example, and the second stage 104 may include steps 206 and 208, for example. In step 202, an operation schedule for a hardware backend is generated through schedule optimization. Then, in step 204, a schedule execution time value is estimated using a runtime estimation process. In step 206, based on the execution time values recorded in the table, an intermediate representation of a neural network model is split. Then, the method proceeds to step 208, the schedules recorded in the table are used in a tensor expression to optimize the tensor expression.

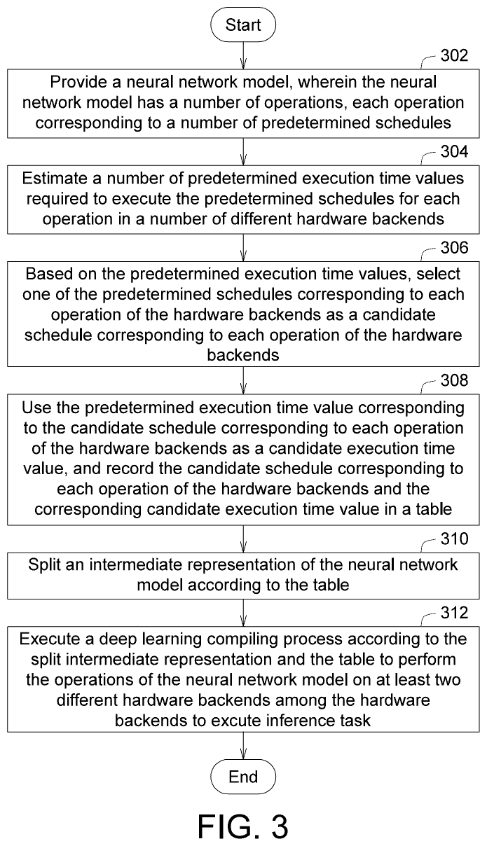

To achieve the above objects, the present disclosure further provides a deep learning compiling method for neural network model. Referring to FIG. 3, a flowchart of a deep learning compiling method for neural network model according to an embodiment of the present disclosure is provided. The deep learning compiling method for neural network model include following steps. Firstly, the method begins at step 302, a neural network model is provided, wherein the neural network model has a number of operations, each operation corresponding to a number of predetermined schedules. Then, the method proceeds to step 304, a number of predetermined execution time values required to execute the predetermined schedules for each operation in a number of different hardware backends are estimated. Then, the method proceeds to step 306, based on the predetermined execution time values, one of the predetermined schedules corresponding to each operation of the hardware backends is selected as a candidate schedule corresponding to each operation of the hardware backends.

Then, the method proceeds to step 308, the predetermined execution time value corresponding to the candidate schedule corresponding to each operation of the hardware backends is used as a candidate execution time value, and the candidate schedule corresponding to each operation of the hardware backends and the corresponding candidate execution time value are recorded in a table. Then, the method proceeds to step 310, an intermediate representation of the neural network model is split according to the table. Then, the method proceeds to step 312, according to the split intermediate representations and the table, a deep learning compiling process is executed to perform the operations of the neural network model on at least two different hardware backends among the hardware backends to execute an inference task. Details of the method are disclosed below.

The operations mentioned above include at least one of convolution operation, pooling operation, add operation, concate operation and rectified linear unit (ReLU) operation. The candidate schedules include a combination of at least one of tiling, unrolling, and caching data on buffer, for example. Each operation can be performed by executing a schedule, such as a combination of at least one of tiling, unrolling and caching data on buffer. For instance, the convolution operation can be carried out by a schedule composed of splitting and caching data on buffer, a schedule composed of splitting and unrolling, or a schedule composed of splitting, unrolling, and caching data on buffer. For instance, different combinations can be represented by different binary values. A number of candidate schedules refer to several schedules capable of achieving specific operations.

In step 304, the estimation of a number of predetermined execution time values required to execute the predetermined schedules for each operation in a number of different hardware backends can be executed by software, such as software package AutoTVM of open-source software deep learning compiler TVM. Details of the deep learning compiler TVM can be obtained with reference to the paper “TVM: An automated end-to-end optimizing compiler for deep learning” by Chen, T., et al., in Proc. of the USENIX Symposium on Operating Systems Design and Implementation, 2018, pp. 578-594″.

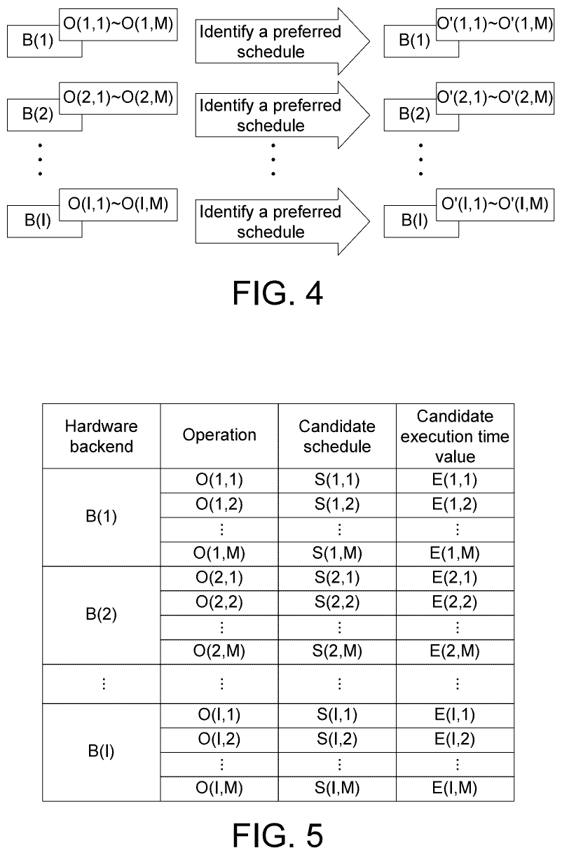

Refer to FIG. 4 and FIG. 5. FIG. 4 is a schematic diagram of identifying a preferred schedule for a number of operations of a neural network model. FIG. 5 is an example of a table recording a number of candidate schedules and candidate execution time values according to an embodiment of the present disclosure. In step 302, a neural network model is provided, wherein the neural network model has a number of operations, and each operation corresponds to a number of predetermined schedules. For instance, suppose the neural network model has a number of operations O(1) to O(M), wherein M is a positive integer. Each of the operations O(1) to O(M) corresponds to k predetermined schedules. For instance, the operation O(1) corresponds to predetermined schedules Sp_1(1) to Sp_k(1), the operation O(2) corresponds to predetermined schedules Sp_1(2) to Sp_k(2), and the operation O(M) corresponds to predetermined schedules Sp_1(M) to Sp_k(M).

Then, in step 304, a number of predetermined execution time values required to execute the predetermined schedules for each operation in a number of different hardware backends are estimated. The different hardware backends are such as hardware backends B(1) to B(I), wherein I is a positive integer. Suppose the operations performed on the hardware backend B(1) are operations O(1, 1) to O(1, M), the operations performed on the hardware backend B(2) is operations O(2, 1) to O(2, M), and the operations performed on the hardware backend B(I) are operations O(I, 1) to O(I, M). Suppose the predetermined execution time values required to execute the predetermined schedules Sp_1(1, 1) to Sp_k(1, 1) for the operation O(1, 1) in the hardware backend B(1) are predetermined execution time values Ep_1(1, 1) to Ep_k(1, 1), the predetermined execution time values required to execute the predetermined schedules Sp_1(1, 2) to Sp_k(1, 2) for the operation O(1, 2) in the hardware backend B(1) are predetermined execution time values Ep_1(1, 2) to Ep_k(1, 2), and the predetermined execution time values required to execute the predetermined schedules Sp_1(1, M) to Sp_k(1, M) for the operation O(1, M) in the hardware backend B(1) are predetermined execution time values Ep_1(1, M) to Ep_k(1, M).

In step 306, based on the predetermined execution time values, one of the predetermined schedules corresponding to each operation of the hardware backends is selected as a candidate schedule corresponding to each operation of the hardware backends. The candidate schedule can be the predetermined schedule having the smallest predetermined execution time value among the predetermined schedules corresponding to each operation of the hardware backends.

For instance, for the predetermined schedules Sp_1(1, 1) to Sp_k(1, 1) of the operation O(1, 1) performed on the hardware backend B(1), one of the predetermined execution time values Ep_1(1, 1) to Ep_k(1, 1) is selected; for instance, the smallest of the predetermined execution time values Ep_1(1, 1) to Ep_k(1, 1) is selected. Suppose the predetermined execution time value Ep_j(1, 1) is selected, wherein j is a positive integer ranging from 1 to k. The predetermined schedule corresponding to the predetermined execution time value Ep_j(1, 1) is predetermined schedule Sp_j(1, 1). The predetermined schedules Sp_j(1, 1) is used as a candidate schedule S(1, 1). Other candidate schedules S(1, 2) to S(1, M) for the operations O(1, 2) to O(1, M) performed on the hardware backend B(1) can be obtained by similar way. The candidate schedule S(2, 1) to S(2, M), S(3, 1) to S(3, M), . . . S(I, 1) to S(I, M) for the operations O(2, 1) to O(2, M), O(3, 1) to O(3, M), . . . . O(I, 1) to O(I, M) performed on the hardware backends B(2) to B(I) can also be obtained by similar way.

In step 308, the predetermined execution time value corresponding to the candidate schedule corresponding to each operation of the hardware backends is used as a candidate execution time value, and the candidate schedule corresponding to each operation of the hardware backends and the corresponding candidate execution time value are recorded in a table. The candidate execution time value includes the sum of an operation time value of the corresponding operation and the time value required to transfer the data of the corresponding operation between two different hardware backends. For an i-th hardware backend, the table further records the time values required to transfer data between the i-th hardware backend and remaining hardware backends, and i is a positive integer less than or equivalent to I.

For instance, since the predetermined execution time value corresponding to the candidate schedule S(1, 1) of the predetermined schedule Sp_j(1, 1) is the predetermined execution time value Ep_j(1, 1), the predetermined execution time value Ep_j(1, 1) can be used as a candidate execution time value E(1, 1). The candidate schedule S(1, 1) corresponding to the operation O(1, 1) of the hardware backends B(1) and the corresponding candidate execution time value E(1, 1) are recorded in a table. As shown in FIG. 5, the candidate execution time values E(1, 2) to E(1, M) for other operations O(1, 2) to O(1, M) performed on the hardware backend B(1) can also be obtained by similar way. The candidate execution time values E(2, 1) to E(2, M), E(3, 1) to E(3, M), . . . . E(I, 1) to E(I, M) for the operations O(2, 1) to O(2, M), O(3, 1) to O(3, M), . . . . O(I, 1) to O(I, M) performed on the hardware backends B(2) to B(I) can also be obtained by similar way. The candidate execution time values E(2, 1) to E(2, M), E(3, 1) to E(3, M), . . . . E(I, 1) to E(I, M) and the corresponding candidate schedules S(2, 1) to S(2, M), S(3, 1) to S(3, M), . . . . S(I, 1) to S(I, M) together are recorded in the table as shown in FIG. 5.

As shown in FIG. 4, after a preferred schedule for the operation O(1, 1) is identified, for instance, after the candidate schedule S(1, 1) is identified, optimization can be performed on the operation O(1, 1) to obtain an optimized operation O′(1, 1). The execution of optimized operation O′(1, 1) is based on the candidate schedule S(1, 1). Other operations O(1, 2) to O(1, M) performed on the hardware backend B(1) can also be optimized based on the candidate schedules S(1, 2) to S(1, M). The operations O(2, 1) to O(2, M), O(3, 1) to O(3, M), . . . . O(I, 1) to O(I, M) performed on the hardware backends B(2) to B(I) can also be optimized based on the candidate schedules S(2, 1) to S(2, M), S(3, 1) to S(3, M), S(1, 1) to S(I, M), as shown in FIG. 4.

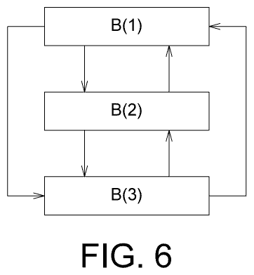

Referring to FIG. 6, a schematic diagram of transferring operation data between different hardware backends is shown. Let I=3 be taken for example, that is, hardware backends are exemplified by hardware backends B(1), B(2) and B(3). The operation time value of an operation refers to the time value required to complete the operation on one hardware backend. After the data of the corresponding operation (such as the output data or tensor) are generated, if the next operation is performed on another hardware backend, extra time value required to transfer data between two different hardware backends will be required. Refer to FIG. 6. For operation performed on the hardware backend B(1), the data generated after the operation is carried out may need to be transferred from the hardware backend B(1) to the hardware backends B(2) or B(3). For operation performed on the hardware backend B(2) is carried out, the data generated after the operation is carried out may need to be transferred from the hardware backend B(2) to the hardware backend B(1) or B(3). For operation performed on the hardware backend B(3) is carried out, the data generated after the operation is carried out may need to be transferred from the hardware backend B(3) to the hardware backend B(1) or B(2).

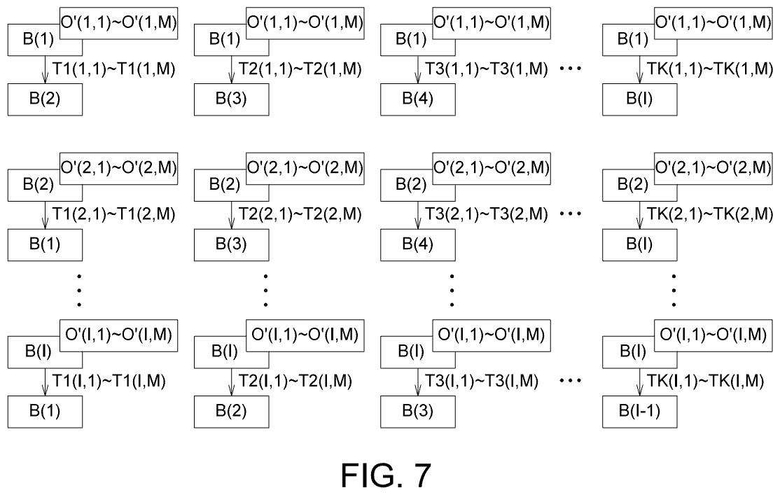

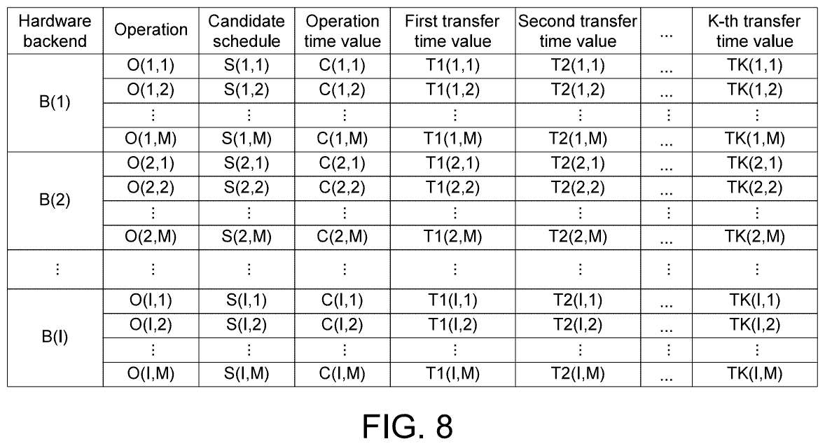

Refer to FIG. 7 and FIG. 8. FIG. 7 is another schematic diagram of transferring operation data between different hardware backends. FIG. 8 is another example of table corresponding to FIG. 7. Step 304 of estimating a number of predetermined execution time values required to execute the predetermined schedules for each operation in a number of different hardware backends may include estimating the time value required to transfer data between two different hardware backends. For instance, after the optimized operation O′(1, 1) performed on the hardware backend B(1) is carried out, the generated data may need to be transferred from the hardware backend B(1) to the hardware backends B(2), B(3) . . . , B(I). Through estimation, the time values required to transfer data from the hardware backend B(1) to the hardware backends B(2), B(3). B(I) respectively are the first transfer time value T1(1, 1), the second transfer time value T2(1, 1) . . . , and the K-th transfer time value TK(1, 1) and are recorded in the table of FIG. 8, wherein K=I−1, K is a positive integer.

Similarly, through estimation, after the optimized operations O′(1, 2) to O′(1, M) performed on the hardware backend B(1) are carried out, the time values required to transfer data from the hardware backend B(1) to the hardware backends B(2), B(3) . . . , B(I) respectively are the first transfer time value T1(1, 2) to T1(1, M), the second transfer time value T2(1, 2) to T2(1, M) . . . , the K-th transfer time value TK(1, 2) to TK(1, M) and are recorded in the table of FIG. 8. Similarly, through estimation, after the optimized operation O′(2, 1) to O′(I, M) performed on the hardware backends B(2) to B(I) are carried out, the time values required to transfer data from the hardware backends B(24) to B(I) to other hardware backends respectively are the first transfer time value T1(2, 1) to T1(I, M), the second transfer time value T2(2, 1) to T2(I, M) . . . , and the K-th transfer time value TK(2, 1) to TK(I, M).

The operation time value of an operation refers to the time value required to complete the operation on a hardware backend. After the data of the corresponding operation (such as the output data or tensor) are generated, if the next operation is performed on another hardware backend, extra data transfer time value between two different hardware backends will be required. For instance, after the operation performed on the hardware backend B(2) is carried out, the generated data may need to be transferred from the hardware backends B(2) to the hardware backends B(1) or B(3). After the operation performed on the hardware backend B(3) is carried out, the generated data may need to be transferred from the hardware backend B(3) to the hardware backend B(1) or B(2). The time values required to transfer data from one hardware backend to another hardware backend are recorded in the table of FIG. 8.

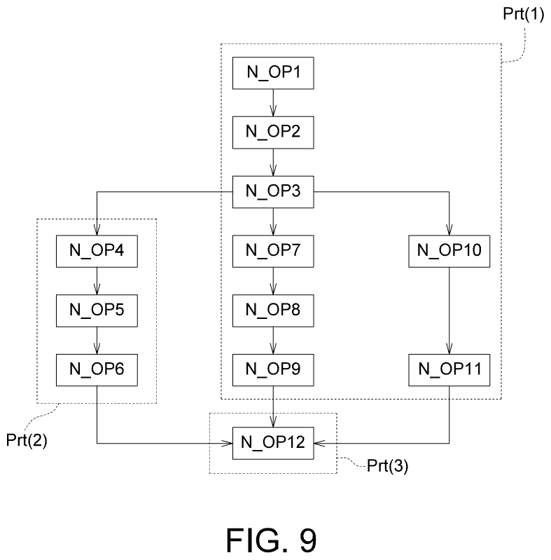

Referring to FIG. 9, a schematic diagram of an intermediate representation for splitting a neural network model is shown. In the step 310 mentioned above, an intermediate representation of the neural network model is split according to the table. In the present step, for a specific operation, the hardware backend corresponding to the candidate schedule having the smallest candidate execution time value is selected from the candidate schedules corresponding to the specific operation of the hardware backends to perform the specific operation.

When the table of FIG. 5 is used, the hardware backends include I hardware backends, such as hardware backends B(1) to B(I). Each hardware backend corresponds to M operations; for instance, the hardware backend B(1) corresponds to the operations O(1, 1) to O(1, M). Each operation corresponds to a candidate schedule and a candidate execution time value; for instance, the operation O(1, 1) corresponds to the candidate schedule S(1, 1) and the candidate execution time value E(1, 1).

For an operation of the intermediate representation, the hardware backend corresponding to one set of candidate schedule and candidate execution time value is selected from I candidate schedules and I candidate execution time values of I hardware backends corresponding to the operation to perform the operation. For instance, for the operation OPx (x is a positive integer ranging from 1 to I), the hardware backend (such as the hardware backend B(y) corresponding to one set of candidate schedule and candidate execution time value (such as candidate schedule S(y, x) and candidate execution time value E(y, x)) is selected from the I candidate schedules (candidate schedules S(1, x) to S(I, x)) and I candidate execution time values (candidate execution time values E(1, x) to E(I, x)) of the I hardware backends (hardware backends B(1) to B(I)) corresponding to the operation OPx to perform the operation OPx. For instance, the hardware backend corresponding to the candidate schedule having the smallest candidate execution time value is selected; for instance, in comparison to the candidate execution time values E(1, x) to E(y−1, x) and E(y+1, x) to E(I, x), the candidate execution time value E(y, x) is the smallest, therefore the hardware backend B(y) corresponding to the candidate execution time value E(y, x) is selected to perform the operation OPx.

For instance, for operation OP2, the hardware backend B(3) corresponding to one set of candidate schedule and candidate execution time value (such as candidate schedule S(3, 2) and candidate execution time value E(3, 2)) is selected from the candidate schedules S(1, 2) to S(I, 2) and candidate execution time values E(1, 2) to E(I, 2) of the hardware backends B(1) to B(I) corresponding to the operation OP2 is selected to perform the operation OP2. In comparison to the candidate execution time values E(1, 2) to E(2, 2) and E(4, 2) to E(I, 2), the candidate execution time value E(3, 2) is the smallest, therefore the hardware backend B(3) corresponding to the candidate execution time value E(3, 2) is selected to perform the operation OP2.

When the table of FIG. 8 is used, the hardware backends include I hardware backends, such as hardware backends B(1) to B(I). Each hardware backend corresponds to M operations; for instance, the hardware backend B(1) corresponds to operations O(1, 1) to O(1, M). Each operation corresponds to an operation time value and K data transfer time values; for instance, the operation O(1, 1) corresponds to operation time value C(1, 1) and data transfer time values T1(1, 1) to TK(1, 1). The K data transfer time values refer to the time values required to transfer the data of the corresponding operation between two corresponding different hardware backends among combinations of K different hardware backends. Combinations of K different hardware backends refers to, for example, combinations of hardware backend B(1) and hardware backends B(2) to B(I) respectively, and the data transfer time values T1(1, 1) to TK(1, 1) refer to the time values required to transfer or move data from the hardware backend B(1) to the hardware backends B(2) to B(I) respectively.

For an operation of the intermediate representation, the hardware backend corresponding to one set of candidate schedule, operation time value and data transfer time value is selected from the I candidate schedules, I operation time values and I*K data transfer time values of the I hardware backends corresponding to the operation to perform the operation. For instance, for an operation OPx of the intermediate representation, the hardware backend B(y) corresponding to one set of candidate schedule, operation time value and data transfer time values (such as candidate schedule S(y, x), operation time value C(y, x), and data transfer time values T1(y, x) to TK(y, x)) is selected from the I candidate schedules (candidate schedules S(1, x) to S(I, x)), I operation time values (the operation time value C(1, x) to C(I, x)) and I*K data transfer time values (data transfer time values T1(1, x) to T1(I, x), T2(1, x) to T2(I, x) . . . , TK(1, x) to T2(I, x)) of the I hardware backends (hardware backends B(1) to B(I)) corresponding to the operation to perform the operation OPx. For instance, the hardware backend corresponding to the candidate schedule having the smallest sum of an operation time value and corresponding data transfer time value is selected. For instance, the hardware backend B(y) corresponding to the candidate schedule S(y, x) having the smallest sum of operation time value C(y, x) and corresponding data transfer time value (one of T1(y, x) to TK(y, x)).

For instance, for operation OP5, the hardware backend B(2) corresponding to one set of candidate schedule, operation time value and data transfer time value (such as candidate schedule S(2, 5), operation execution time values E(2, 5), and one of T1(2, 5) to TK(2, 5)) is selected from the candidate schedules (candidate schedules S(1, 5) to S(I, 5)), operation time values C(1, 5) to C(I, 5) and data transfer time values T1(1, 5) to T1(1, 5), T2(1, 5) to T2(1, 5) . . . , TK(1, 5) to TK(I, 5)) of the hardware backends B(1) to B(I) corresponding to the operation to perform the operation OP5. In comparison to the sum of other operation time value and corresponding data transfer time value, the sum of operation time value C(2, 5) and corresponding data transfer time value (one of T1(2, 5) to TK(2, 5)) is the smallest, therefore the hardware backend B(2) corresponding to the candidate schedule S(2, 5) is selected to perform the operation OP5.

FIG. 9 illustrates an example of an intermediate representation of a split neural network model. The intermediate representation of a neural network model has a number of nodes, such as nodes N_OP1 to N_OP12, respectively, corresponding to operations OP1 to OP12 of the neural network model. Each operation consumes at least one tensor and generates at least another tensor, wherein tensor refers to the data processed when an operation is performed or the data generated after the operation is carried out.

The split intermediate representation at least includes a first part and a second part. The first part has a first operation; the second part has a second operation. The hardware backends at least include a first hardware backend and a second hardware backend. The first operation is performed on the first hardware backend; the second operation is performed on the second hardware backend.

Assume after step 310 mentioned above is performed, that is, an intermediate representation of the neural network model is split according to the table, for a specific operation, the hardware backend corresponding to the candidate schedule having the smallest candidate execution time value is selected from the candidate schedules corresponding to the specific operation of the hardware backends to perform the specific operation, an intermediate representation of the split neural network model of FIG. 9 is obtained. The split intermediate representation includes a first part Prt (1), a second part Prt (2), and a third part Prt (3). The first part Prt (1) has nodes N_OP1 to N_OP3 and nodes N_OP7 to N_OP11, respectively corresponding to operations OP1 to OP3 and operations OP7 to OP11. The second part Prt (2) has nodes N_OP4 to N_OP6, respectively corresponding to operation OP4 to OP6. The third part Prt (3) has node N_OP12, corresponding to operation OP12. Assume the schedules corresponding to the nodes of the first part Prt (1) to the third part Prt (3) are executed in different hardware backends. For instance, the operations corresponding to the nodes of the first part Prt (1) are performed on the hardware backend B(3), the operations corresponding to the nodes of the second part Prt (2) are performed on the hardware backend B(2), and the operation corresponding to the node of the third part Prt (3) is performed on the hardware backend B(1).

For instance, the operations OP1 to OP3 respectively are convolution operation, add operation, and ReLU operation; the operations OP4 to OP6 respectively are convolution operation, add operation, and ReLU operation; the operations OP7 to OP11 respectively are convolution operation, add operation, ReLU operation, convolution operation, and ReLU operation; the operation OP12 is concate operation.

Since the operation corresponding to each node of the intermediate representation of the neural network model selects the hardware backend corresponding to the schedule having the smallest or smaller execution time value and is performed on at least two different hardware backends, overall execution time value of all operations of the entire neural network model will be smaller than the time value required to perform all operations on the same hardware backend.

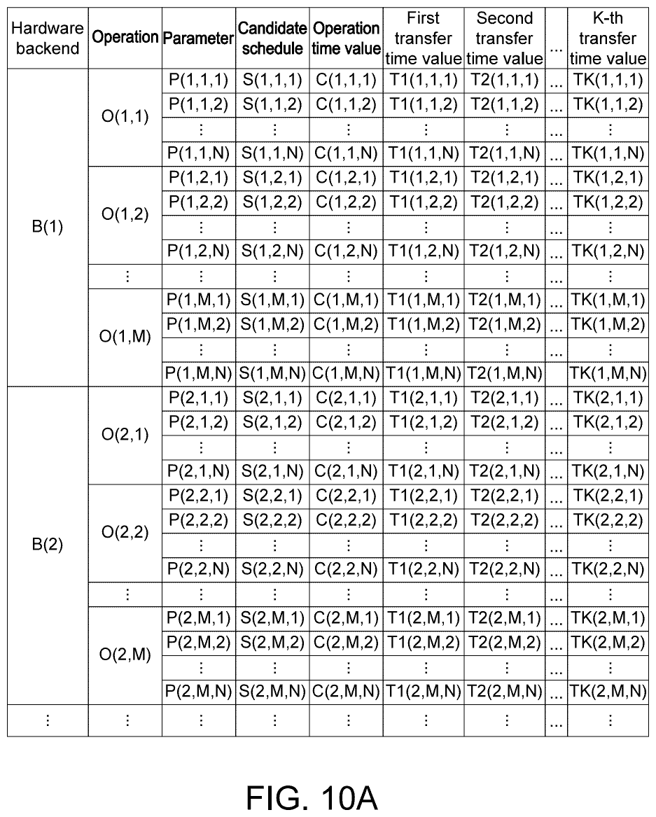

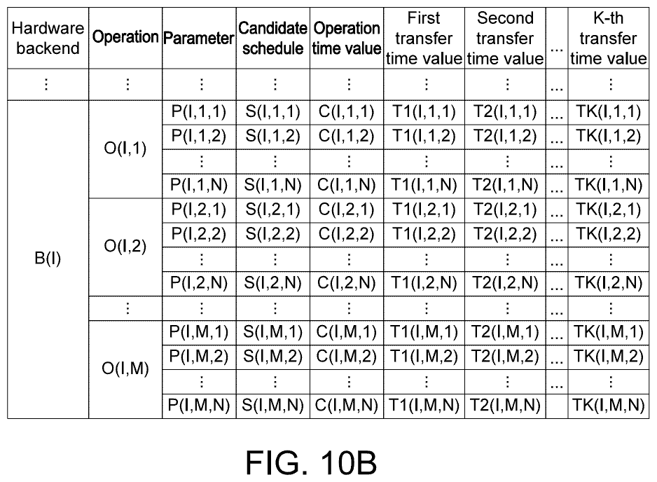

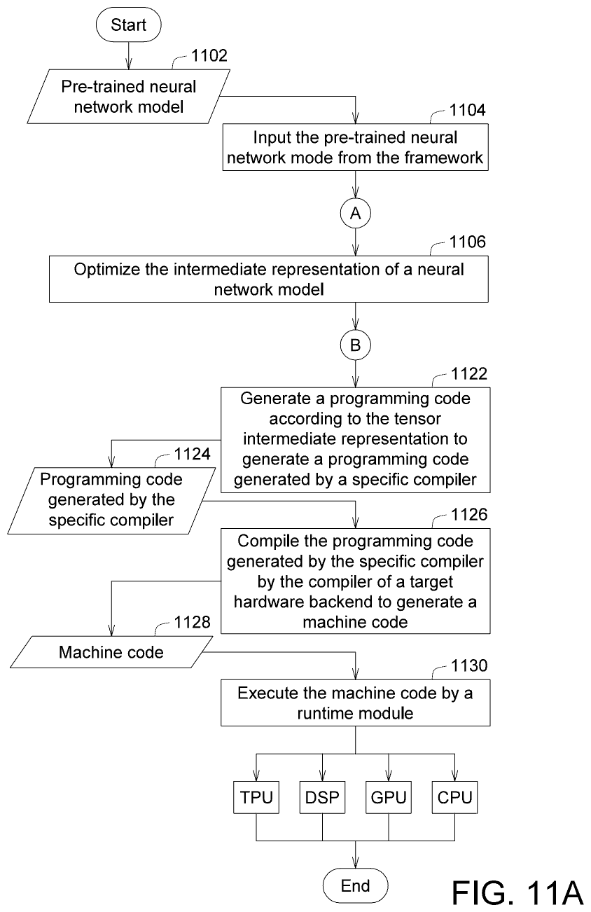

Referring to FIGS. 10A and 10B, an example of a table recording the candidate schedules and candidate execution time values corresponding to at least one parameter corresponding to each operation is shown. As shown in FIGS. 10A and 10B, the table further records the candidate schedule S and candidate execution time value (corresponding to the sum of operation time value C and one of the transfer time values T1 to TK) corresponding to at least one parameter P corresponding to each operation. The at least one parameter P include at least one of input size, weight size, and stride.

For instance, the hardware backends include I hardware backends, such as hardware backends B(1) to B(I). Each hardware backend corresponds to M operations; for instance, the hardware backend B(1) corresponds to operation O(1, 1) to O(1, M). Each operation corresponds to N parameters; for instance, the operation O(1, 1) corresponds to parameters P(1, 1, 1) to P(1, 1, N). Each parameter corresponds to an operation time value and K data transfer time values; for instance, the parameter P(1, 1, 1) corresponds to operation time value C(1, 1, 1) and data transfer time values T1(1, 1, 1) to TK(1, 1, 1). K data transfer time values refer to the time values required to transfer the data of the corresponding operation between two corresponding different hardware backends among combinations of K different hardware backends. Combinations of K different hardware backends refers to combinations of hardware backend B(1) and hardware backends B(2) to B(I); data transfer time values T1(1, 1, 1) to TK(1, 1, 1) refer to the time values required to transfer or move data from the hardware backend B(1) to the hardware backends B(2) to B(I) respectively.

For an operation having a parameter of the intermediate representation, the hardware backend corresponding to one set of candidate schedule, operation time value and data transfer time value is selected from the I candidate schedules, I operation time values and I*K data transfer time values of the I hardware backends corresponding to the parameter and the operation to perform the operation. For instance, for an operation OPx having a parameter Pz of the intermediate representation (z is a positive integer between 1 and N), the I candidate schedules (candidate schedules S(1, x, z) to S(I, x, z)), I operation time values (operation time values C(1, x, z) to C(I, x, z)) and I*K data transfer time values (data transfer time values T1(1, x, z) to T1(I, X, z), T2(1, x, z) to T2(I, x, z) . . . , TK(1, x, z) to TK(I, x, z)) of the I hardware backends (hardware backends B(1) to B(I)) corresponding to the parameter and operation, the hardware backend B(y) corresponding to one set of candidate schedule, operation time value and data transfer time value (such as candidate schedule S(y, x, z), operation time value C(y, x, z), and one of data transfer time values T1(y, x, z) to TK(y, x, z)) is selected to perform the operation OPx having a parameter Pz. For instance, the hardware backend corresponding to the candidate schedule having the smallest sum of operation time value and corresponding data transfer time value is selected. For instance, the hardware backend B(y) corresponding to the candidate schedule S(y, x, z) having the smallest sum of operation time value C(y, x, z) and corresponding data transfer time value (one of T1(y, x, z) to TK(y, x, z)) is selected.

For instance, for an operation OP5 having a parameter P6 of the intermediate representation, the hardware backend B(2) corresponding to one set of candidate schedule, operation time value and data transfer time value (such as candidate schedule S(2, 5, 6), operation time value C(2, 5, 6), and one of data transfer time value T1(2, 5, 6) to TK(2, 5, 6)) is selected from the I candidate schedules (candidate schedules S(1, 5, 6) to S(I, 5, 6)), I operation time values (operation time values C(1, 5, 6) to C(I, 5, 6)) and I*K data transfer time values (data transfer time values T1(1, 5, 6) to T1(I, 5, 6), T2(1, 5, 6) to T2(1, 5, 6) . . . , TK(1, 5, 6) to TK(I, 5, 6)) of the I hardware backends (hardware backends B(1) to B(I)) corresponding to the operation and the parameter to perform the operation OP5 having a parameter P6.

Then, the method proceeds to step 312 mentioned above, according to the split intermediate representations and the table, a deep learning compiling process is executed to perform the operations of the neural network model on at least two different hardware backends among the hardware backends and an inference task. As shown in FIG. 9, based on the intermediate representation, which has been split into a first part Prt (1), a second part Prt (2), and a third part Prt (3), and the table of FIG. 5, FIG. 8 or FIGS. 10A and 10B, a deep learning compiling process is executed. After the deep learning compiling process is completed, the operations of the neural network model are performed on the hardware backends B(1), B(2) and B(3) of the hardware backends B(1) to B(I) to perform an inference task. For instance, the operations OP1 to OP3 corresponding to the nodes N_OP1 to N_OP3 and the operations OP7 to OP11 corresponding to the nodes N_OP7 to N_OP11 are performed on the hardware backend B(3) corresponding to the first part Prt (1), the operations OP4 to OP6 corresponding to the nodes N_OP4 to N_OP6 are performed on the hardware backend B(2) corresponding to the second part Prt (2), and the operation OP12 corresponding to the node N_OP12 is performed on the hardware backend B(1) corresponding to the third part Prt (3) to perform an inference task. Since each of the operations OP1 to OP12 can select a hardware backend which can perform corresponding operation faster to perform corresponding operation, the neural network model of the present disclosure can complete inference faster and more efficiently.

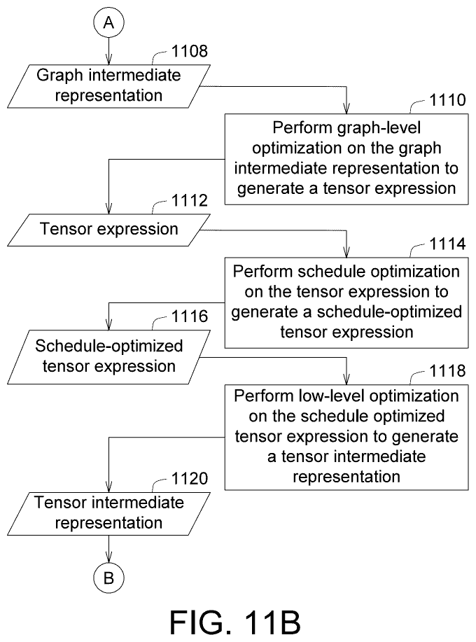

Refer to FIGS. 11A and 11B. FIG. 11A is a flowchart of an example of complete action of a compiler using a deep learning compiling method for neural network model according to the present disclosure. FIG. 11B is a flowchart of detailed steps of step 1106 of FIG. 11A. Parallelogram represents input or output files or information; rectangle represents action to be executed.

Firstly, a pre-trained neural network model 1102 is provided. Then, the method proceeds to step 1104, the pre-trained neural network model 1102 is inputted from the framework. Then, the method proceeds to step 1106, the intermediate representation of a neural network model is optimized. As shown in FIG. 11B, step 1106 includes steps 1110, 1114 and 1118.

In step 1110, graph-level optimization is performed on the graph intermediate representation 1108 to generate a tensor expression 1112. In step 1114, schedule optimization is performed on the tensor expression 1114 to generate a schedule-optimized tensor expression 1116.

In step 1118, low-level optimization is performed on the schedule optimized tensor expression 1116 to generate a tensor intermediate representation 1120. The tensor expression 1116 corresponding to a specific operation schedule optimization is optimized according to the candidate schedule corresponding to the specific operation.

Then, the method proceeds to step 1122, a programming code is generated according to the tensor intermediate representation 1120 to generate a programming code 1124 generated by a specific compiler. Then, the method proceeds to step 1126, the programming code 1124 generated by the specific compiler is compiled by the compiler of a target hardware backend to generate a machine code 1128. In step 1130, the machine code 1128 is executed by a runtime module then the programming code is transmitted to at least two corresponding hardware backends and executed by the at least two corresponding hardware backends. The above hardware backends include at least two of central processing unit (CPU), digital signal processing (DSP), graphics processing unit (GPU), tensor processing unit (TPU), microcontroller unit (MCU), field-programmable gate array (FPGA), and neural-network processing unit (NPU).

The data structure used in the deep learning compiler is explained below. The graph intermediate representation refers to a high-level intermediate representation, such as the relay of a deep learning compiler TVM. The graph intermediate representation can be regarded as a computational graph; each node of the graph intermediate representation represents an operation which consumes tensors and generates tensors.

The tensor expression is a domain-specific language used to describe tensor calculation for the user to construct a tensor intermediate representation. The tensor expression provides many schedule primitive expressions to specify low-level loop optimization. The tensor expression include, for example, tiling, vectorization, parallelization, unrolling and fusion.

The tensor intermediate representation, being a low-level intermediate representation of a deep learning compiler TVM, includes elements such as loop-nest choices, multi-dimensional load/store, threading and vector/tensor instructions.

The optimization of a deep learning compiler includes graph-level optimization, schedule optimization, and low-level optimization. The graph-level optimization includes common program optimization, such as constant folding and dead-code elimination, and tensor-computation specific passes. The tensor-computation specific passes are, for example, layout transformation and scaling factor folding. The schedule optimization uses a schedule to represent specific mapping from a tensor expression to a low-level programming code. The schedule is constructed by incrementally using basic conversion, which preserves program logical equivalence. The low-level optimization flattens multi-dimensional access as one-dimensional pointer access, expands the intrinsics to target specific intrinsics, and achieves access index simplification. Other low-level optimization can be processed using LLVM compiler, NVCC (Nvidia CUDA) compiler or other target compilers.

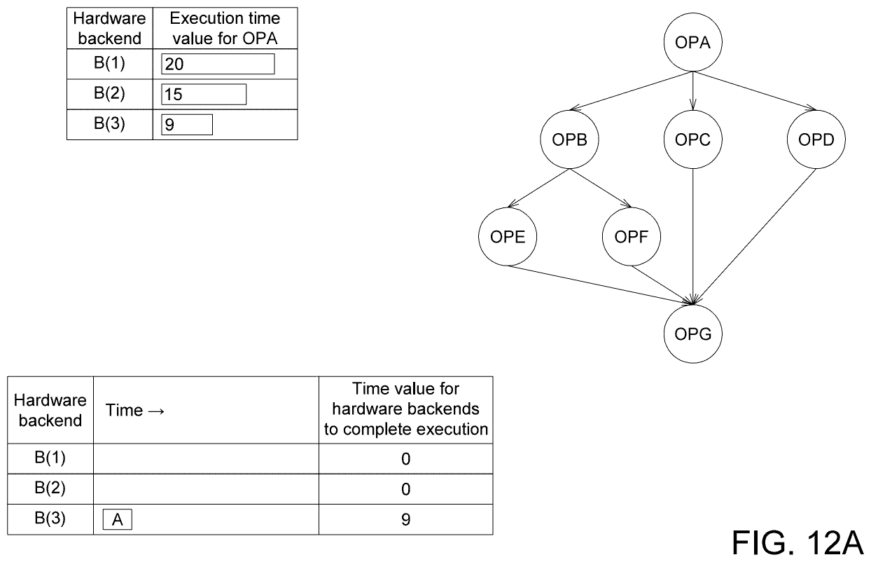

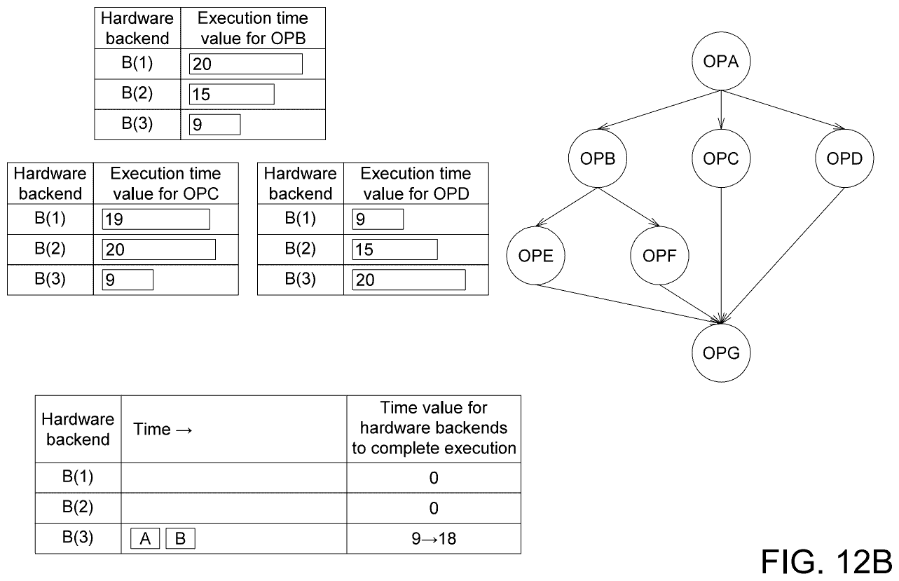

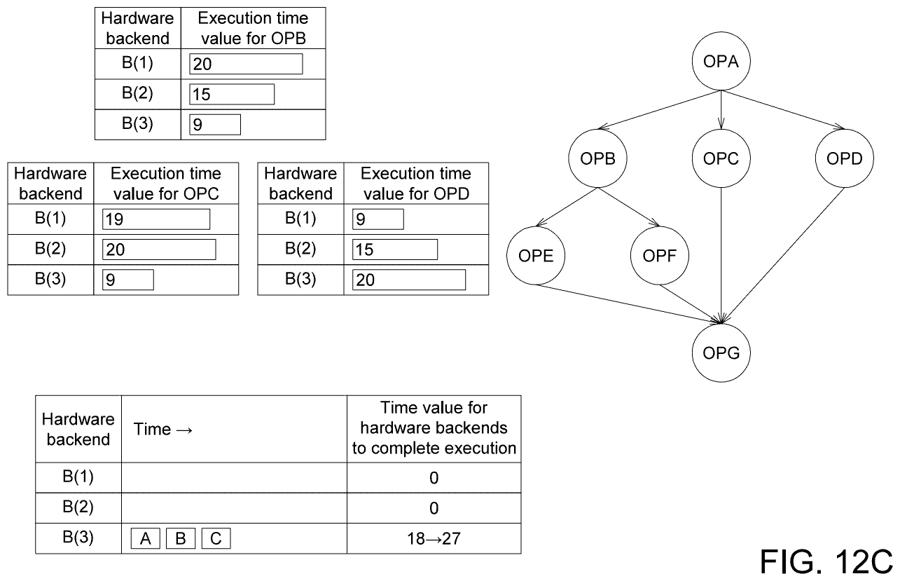

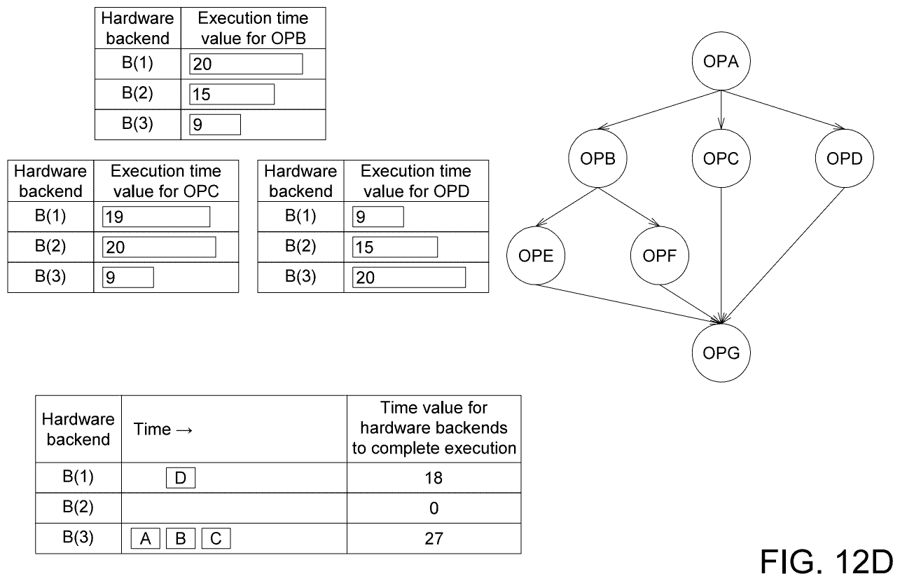

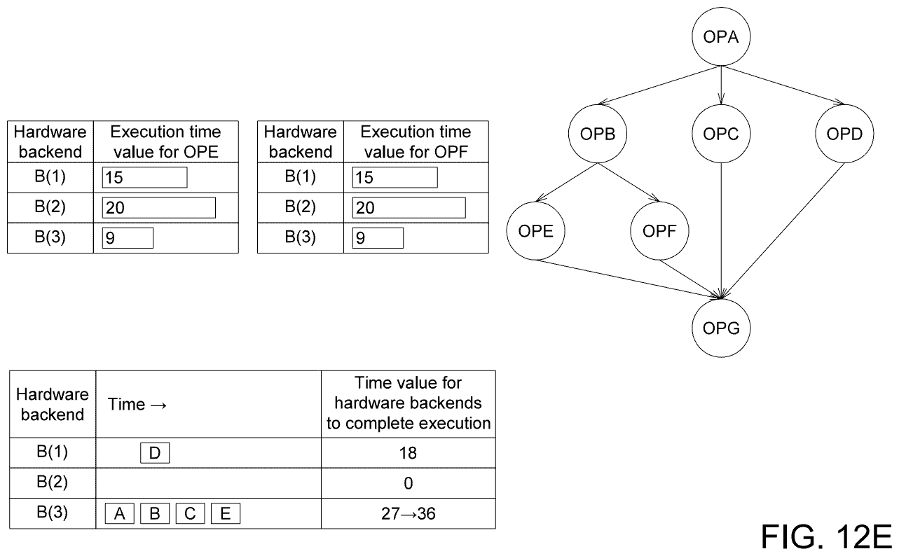

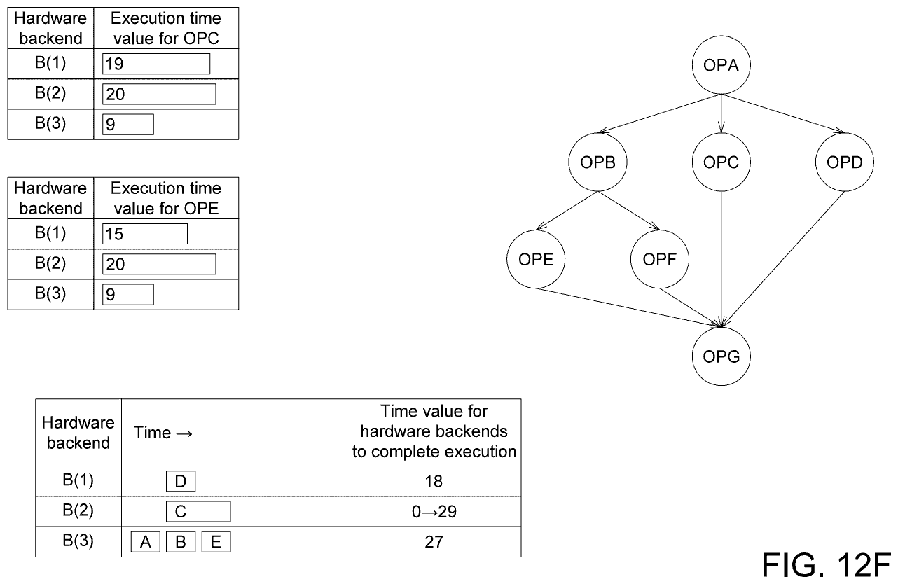

Referring to FIGS. 12A to 12F, an example of executing a deep learning compiling method for neural network model according to an embodiment of the present disclosure is shown. FIGS. 12A to 12F illustrate an example of performing the operations OPA to OPG of a neural network model on hardware backends B(1) to B(3). For each of the operations OPA to OPG, the hardware backend corresponding to the candidate schedule having the smallest candidate execution time value is selected from the candidate schedules listed in the table of FIG. 5, FIG. 8, or FIGS. 10A and 10B corresponding to the operations OPA to OPG of the hardware backends B(1) to B(3) to perform the operations OPA to OPG. To simplify the descriptions, the execution time value includes the operation time value only, and excludes the time value required to transfer the data of the corresponding operation between two different hardware backends.

As shown in FIG. 12A, when the operation OPA is performed on the hardware backend B(3), the execution time value of the operation OPA is the smallest, therefore the hardware backend B(3) is selected to perform the operation OPA. As shown in FIG. 12B, when the operation OPB is performed on the hardware backend B(3), the execution time value of the operation OPB is the smallest, therefore the hardware backends B(3) is selected to perform the operation OPB. As shown in FIG. 12C, when the operation OPC is performed on the hardware backend B(3), the execution time value of the operation OPC is the smallest, therefore the hardware backends B(3) is selected to perform the operation OPC. As shown in FIG. 12D, when the operation OPD is performed on the hardware backend B(1), the execution time value of the operation OPD is the smallest, therefore the hardware backends B(1) is selected to perform the operation OPD. As shown in FIG. 12E, when the operation OPE is performed on the hardware backend B(3), the execution time value of the operation OPE is the smallest, therefore the hardware backends B(3) is selected to perform the operation OPE. As shown in FIG. 12F, since the hardware backend B(2) currently is in an idle state, the operation OPC can be selectively performed on the hardware backend B(2) to reduce the overall execution time value of the hardware backends B(1) to B(3).

Experimental results show that when all operations are performed on the same hardware backend (such as NPU), an execution speed of 11.7714 frames per second can be obtained. When the deep learning compiling method for neural network model of the present disclosure designed using C++ is executed on CPU, GPU, and NPU concurrently, the execution speed of operation can be increased by at least 1.35 times.

A non-transitory computer readable media for storing the program of a deep learning compiling method for neural network model mentioned above is further provided according to an embodiment of the present disclosure. The deep learning compiling method for neural network model mentioned above according to an embodiment of the present disclosure can be executed by a computer system, a server system or a mobile device. The computer system, the server system or the mobile device at least has a processor and a storage device. The processor is used to execute the deep learning compiling method for neural network model mentioned above according to an embodiment of the present disclosure, and the storage device is used to store a corresponding programming code or to-be-used data and generated data.

The deep learning compiling method for neural network model and the non-transitory computer readable media for storing the program thereof according to an embodiment of the present disclosure are capable of effectively optimizing and running a neural network model on any hardware backends and running the neural network model on any combination of hardware backends. Furthermore, deployment complexity of the neural network model will not increase when more hardware backends are considered or the combination of hardware backends becomes more complicated. The deep learning compiling method for neural network model according to an embodiment of the present disclosure is capable of filtering off non-supported or inferior operation schedules. Since superior schedules and their corresponding execution time values can be obtained from the table, the overall time value required to compile the neural network model can be reduced and inference processing speed of the neural network model can be increased.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A deep learning compiling method for neural network model, comprising:
providing a neural network model, wherein the neural network model has a plurality of operations, and each operation corresponds to a plurality of predetermined schedules;
estimating a plurality of predetermined execution time values required to execute the predetermined schedules for each operation in a plurality of different hardware backends;
based on the predetermined execution time values, selecting one of the predetermined schedules corresponding to each operation of the hardware backends as a candidate schedule corresponding to each operation of the hardware backends;
using the predetermined execution time value corresponding to the candidate schedule corresponding to each operation of the hardware backends as a candidate execution time value, and recording the candidate schedule corresponding to each operation of the hardware backends and the corresponding candidate execution time value in a table;
splitting an intermediate representation of the neural network model according to the table; and
executing a deep learning compiling process according to the split intermediate representation and the table to perform the operations of the neural network model on at least two different hardware backends among the hardware backends to execute an inference task.

2. The method according to claim 1, wherein the split intermediate representation at least comprises a first part and a second part, the first part has a first operation, and the second part has a second operation; the hardware backends at least comprise a first hardware backend and a second hardware backend, the first operation is performed on the first hardware backend, and the second operation is performed on the second hardware backend.

3. The method according to claim 1, wherein the candidate schedule is the predetermined schedule having the smallest predetermined execution time value among the predetermined schedules corresponding to each operation of the hardware backends.

4. The method according to claim 1, wherein in the step of executing the deep learning compiling process according to the split intermediate representation and the table, for a third operation, the hardware backend corresponding to the candidate schedule having the smallest candidate execution time value is selected from the candidate schedules corresponding to the third operation of the hardware backends to perform the third operation.

5. The method according to claim 4, wherein the neural network model further comprises a tensor expression corresponding to the third operation, and the tensor expression is optimized according to the candidate schedule corresponding to the third operation.

6. The method according to claim 1, wherein the intermediate representation has a plurality of nodes respectively corresponding to the operations of the neural network model, and each operation consumes at least one first tensor and generates at least one second tensor.

7. The method according to claim 1, wherein the candidate execution time value comprises the sum of an operation time value of the corresponding operation and the time value required to transfer the data of the corresponding operation between two different hardware backends.

8. The method according to claim 1, wherein the hardware backends comprise a first hardware backend and a second hardware backend to an I-th hardware backend, for an i-th hardware backend, the table further records the time values required to transfer data between the i-th hardware backend and remaining hardware backends, and i is a positive integer less than or equivalent to I, I is an positive integer.

9. The method according to claim 1, wherein the hardware backends comprise at least two of central processing unit (CPU), digital signal processing (DSP), graphics processing unit (GPU), tensor processing unit (TPU), microcontroller unit (MCU), field-programmable gate array (FPGA), and neural-network processing unit (NPU).

10. The method according to claim 1, wherein the operations comprise at least one of convolution operation, pooling operation, add operation, concate operation and rectified linear unit (ReLU) operation.

11. The method according to claim 1, wherein the candidate schedules comprise combinations of at least one of tiling, unrolling, and caching data on buffer.

12. The method according to claim 1, wherein the hardware backends comprise I hardware backends, each hardware backend corresponds to M operations, and each operation corresponds to a candidate schedule and a candidate execution time value, I is a positive integer;
wherein for a first operation of the intermediate representation, the hardware backend corresponding to one set of candidate schedule and candidate execution time value is selected from the I candidate schedules and I candidate execution time values of the I hardware backends corresponding to the first operation to perform the first operation.

13. The method according to claim 12, wherein in the step of selecting the hardware backend corresponding to one set of candidate schedule and candidate execution time value from the I candidate schedules and I candidate execution time values of the I hardware backends corresponding to the first operation to perform the first operation, the hardware backend corresponding to the candidate schedule having the smallest candidate execution time value is selected.

14. The method according to claim 1, wherein the hardware backends comprise I hardware backends, each hardware backend corresponds to M operations, each operation corresponds to an operation time value and K data transfer time values, and the K data transfer time values refer to the time values required to transfer the data of the corresponding operation between two corresponding different hardware backends among combinations of K different hardware backends, I, M, K are positive integers;
wherein for a first operation of the intermediate representation, the hardware backend corresponding to one set of candidate schedule, operation time value and data transfer time value is selected from the I candidate schedules, I operation time values and I*K data transfer time values of the I hardware backends corresponding to the first operation to perform the first operation.

15. The method according to claim 14, wherein in the step of selecting the hardware backend corresponding to one set of candidate schedule, operation time value data transfer time value from the I candidate schedules, I operation time values and I*K data transfer time values of in the I hardware backends corresponding to the first operation to perform the first operation, the hardware backend corresponding to the candidate schedule having the smallest sum of operation time value and corresponding data transfer time value is selected.

16. The method according to claim 1, wherein the table further records the candidate schedule and candidate execution time value corresponding to at least one parameter corresponding to each operation.

17. The method according to claim 16, wherein the at least one parameter comprises at least one of input size, weight size, and stride.

18. The method according to claim 16, wherein the hardware backends comprise I hardware backends, each hardware backend corresponds to M operations, each operation corresponds to N parameters, each parameter corresponds to an operation time value and K data transfer time values, and the K data transfer time values refer to the time values required to transfer the data of the corresponding operation between two corresponding different hardware backends among combinations of K different hardware backends, and I, M, N, K are positive integers;
wherein for a first operation having a first parameter of the intermediate representation, the hardware backend corresponding to one set of candidate schedule, operation time value and data transfer time value is selected from the I candidate schedules, I operation time values and I*K data transfer time values of the I hardware backends corresponding to the first operation and the first parameter to perform the first operation having the first parameter.

19. The method according to claim 18, wherein in the step of selecting the hardware backend corresponding to one set of candidate schedule, operation time value data transfer time value from the I candidate schedules, I operation time values and I*K data transfer time values of the I hardware backends corresponding to the first operation and the first parameter to perform the first operation, the hardware backend corresponding to the candidate schedule having the smallest sum of operation time value and corresponding data transfer time value is selected.

20. A non-transitory computer readable media used to store a programming code for executing the method of claim 1.
